(19) United States
(12) Patent Application Publication
(10) Pub. No.: US 2013/0264395 A1
(43) Pub. Date: Oct. 10, 2013

(54) WEDGE INSERT FOR A POWDER TUBE EXTENSION OF A POWDER SPRAY GUN OPERABLE AT HIGH VOLTAGE, AND POWDER TUBE EXTENSION WITH WEDGE INSERT

(71) Applicant: J. WAGNER AG, Altstatten (CH)

(72) Inventors: Pierre PLASCAR, Goppingen (DE); Thomas SCHWARZ, St. Gallen (CH); Raphael GRAF, Au (CH); Thomas NAUER, Rebstein (CH)

(73) Assignee: J. WAGNER AG, Altstatten (CH)

(21) Appl. No.: 13/858,144

(22) Filed: Apr. 8, 2013

(30) Foreign Application Priority Data
Apr. 10, 2012 (EP) 12 405 035 .2

(51) Int. Cl. B05B 1/04

(52) U.S. Cl. CPC B05B 1/04
USPC 239/1; 239/590

(57) ABSTRACT

The wedge insert for a powder tube extension of a powder spray gun operable at high voltage comprises a sleeve, wherein the sleeve has a radial web, which is wedge-shaped on the upstream side. In addition, an axially running channel, into which a guide tube, which guides an electrode with a high voltage, can be inserted, is provided in the web.

### TECHNICAL FIELD

A wedge insert is provided for a powder tube extension of a powder spray gun operable at high voltage and to a powder tube extension with wedge insert for a powder spray gun operable at high voltage.

In the case of electrostatic powder coating, the workpiece to be coated is covered by a layer of electrostatically charged powder in a first process step using a powder spray gun. In a subsequent process step, the workpiece coated with the powder is heated until the powder on the surface of the workpiece melts and a closed layer is formed. Once the workpiece has cooled, this layer is a closed protective layer adhering fixedly to the workpiece. An electrode holder with an electrode under high voltage is located in the powder spray gun so that the powder can be electrostatically charged. The powder flows past the electrode and in so doing is electrostatically charged. The high voltage applied to the electrode is generally between 20 kV and 100 kV.

Workpieces having relatively large dimensions and relatively large indentations often have areas that the coater cannot reach using a conventional powder spray gun or that the coater can only reach with difficulty. A conventional powder spray gun is equipped with a powder tube extension so that such workpieces however can also be coated with high quality. To this end, in the case of the powder spray gun, the spray nozzle, the electrode holder and the cap nut, which fixes the spray nozzle and the electrode holder on the gun, are first removed and the powder tube extension is then screwed onto the gun. The gun can then be introduced more deeply into the workpiece, and these areas of the workpiece, which would otherwise be inaccessible, can be better accessed.

### PRIOR ART

The embodiment of a powder tube extension shown in FIGS. 1a and 1b forms a prior art that is already known. The tube 900, which contains the resistors 110 for the electrode 800, is centred via three centering pins 300 arranged in a star-shaped manner. The centering pins 300 are fitted through the powder tube 200 radially from the outside. The nozzle 100 is then slid over the gun base and the pins 300 and is screwed onto the thread provided for this purpose on the gun base. The pins 300 are thus themselves fixed and fix the tube 900, in which the resistors 110 and the electrode 800 are located. This type of centering is complex. In addition, the centering pins 300 are relatively small component parts, which may be lost handled carelessly. A further disadvantage of the centering pins 300 is that they protrude into the powder tube 200 and are subject to the flow of coating powder. The wear is not insignificant, in particular in the case of abrasive powder. In addition, the centering pins 300 influence the powder flow so that said flow is swirled and no longer exits the nozzle 100 uniformly.

### SUMMARY OF THE INVENTION

An object of the invention is to specify a wedge insert for a powder tube extension of a powder spray gun operable at high voltage and a powder tube extension with wedge insert for a powder spray gun operable at high voltage, wherein the powder flow is not influenced by the wedge insert, or is only influenced to a minimal extent.

The use of the wedge insert according to the invention in the powder tube extension advantageously means that the powder tube extension as a whole no longer has a negative influence on the powder jet. A powder spray gun that is operated with a powder tube extension thus equipped generates the same powder jet, or approximately the same powder jet, as when it is operated without the powder tube extension.

The object is achieved by a wedge insert for a powder tube extension of a powder spray gun operable at high voltage having the features disclosed herein.

The wedge insert according to the invention for a powder tube extension of a powder spray gun operable at high voltage comprises a sleeve, wherein the sleeve has a radial web, which is formed in a wedge-shaped manner on the upstream side. In addition, an axially running channel, into which a guide tube, which guides an electrode for the high voltage, can be inserted, is provided in the web.

The object is achieved by a powder tube extension with wedge insert for a powder spray gun operable at high voltage having the features disclosed herein.

The proposed powder tube extension for a powder spray gun operable at high voltage with the above-described wedge insert has a central guide tube, in which resistors are arranged. In addition, a powder tube arranged concentrically with the guide tube is provided. The wedge insert and a spray nozzle are provided at the downstream end of the powder tube.

Advantageous developments of the invention will emerge from the features disclosed herein.

In an embodiment of the wedge insert according to the invention, a lug is provided, which is formed such that, when the wedge insert is fitted in a spray nozzle having a groove, it forms an interlocking connection together with the groove.

In a further embodiment of the wedge insert according to the invention, the channel is sleeve-shaped and is arranged concentrically with the sleeve.

In another embodiment of the wedge insert according to the invention, the sleeve is formed in such a way that it can be inserted into a powder tube of the powder tube extension and in so doing forms a frictional connection with the powder tube.

In a development of the wedge insert according to the invention, the sleeve tapers in the upstream end region.

In a development of the powder tube extension, a cap is provided, which is connected to the guide tube by means of a detachable connection. If the cap or the electrode needle in the cap is worn, the cap can be easily removed with the electrode needle and can be replaced by a new cap. There is no need for any service personnel for this purpose.

In another development of the powder tube extension, a groove is provided in the spray nozzle and is formed such that it forms an interlocking connection with the lug of the wedge insert. The spray nozzle thus always has the same orientation as the wedge insert. This in turn ensures that the quality of the powder spray jet is constantly high in a long-lasting manner.

With the powder tube extension, a latched connection may be provided between the spray nozzle and the powder tube. The spray nozzle is thus fixed on the powder tube and can be removed as required without the use of a tool.

The latched connection can be enabled with the powder tube extension since the spray nozzle has an O-ring and the powder tube has a groove. This is a simple and cost-effective solution.

In an embodiment of the powder tube extension, the spray nozzle has a sleeve-shaped portion, which can be fitted onto the powder channel. The path between the powder channel and the end of the spray nozzle is thus extended. As a result of this design measure, various national and international standards are met. These standards stipulate that the powder spray gun must not present an explosion risk. Ignitable partial discharges (discharges in the ionised air) and/or ignitable flashovers (discharges to a much lower potential or to earth) have to be prevented. Partial discharges and flashovers may occur if a distance dependant on the level of the high voltage and the field strength present is undershot.

In a further embodiment of the powder tube extension, a baffle plate is provided, which can be fitted onto the guide tube. A conical powder spray jet can thus be generated.

In addition, a flat jet nozzle, with which a nozzle slit and a tubular portion are provided, is proposed for a powder tube extension of a powder spray gun operable at high voltage. The tubular portion is formed in such a way that at least the downstream portion of a radially arranged wedge of a wedge insert can be placed therein with an interlocking fit. A groove is provided in a further tubular portion of the flat jet nozzle and is formed such that, when the wedge insert is connected to the flat jet nozzle, said groove forms an interlocking connection with the lug of the wedge insert so that the wedge and the nozzle slit have the same orientation. A step is provided between the tubular portion and the further tubular portion.

Lastly, the above-described powder tube extension can be used in a manually operable powder spray gun, an automatic spray gun or a powder beaker gun.

### BRIEF DESCRIPTION OF THE DRAWINGS

The invention will be explained in greater detail hereinafter with a plurality of exemplary embodiments with reference to 17 figures.

FIG. 1a shows a longitudinal sectional view of a powder tube extension for a powder spray gun as is known from the prior art.

FIG. 1b shows a three-dimensional view of the downstream portion of the powder tube extension from FIG. 1a.

FIG. 2 shows a longitudinal sectional view of a first possible embodiment of the powder tube extension according to the invention.

FIG. 3 shows a longitudinal sectional view, rotated through 90°, of a second possible embodiment of the powder tube extension according to the invention.

FIG. 4 shows a three-dimensional view of the powder tube extension according to the invention in the disassembled state.

FIG. 5 shows a three-dimensional view of the powder tube extension according to the invention with a flat jet nozzle in the assembled state.

FIG. 6 shows a three-dimensional view of the powder tube extension according to the invention, wherein the flat jet nozzle is detached.

FIG. 7 shows a three-dimensional view of the powder tube extension according to the invention, wherein the flat jet nozzle and the wedge insert are detached.

FIG. 8 shows a three-dimensional view of the downstream portion of the powder tube extension according to the invention, wherein the cap for the high-voltage electrode is detached.

FIG. 9 shows a three-dimensional view of the powder tube extension according to the invention, wherein the O-ring and the cap nut are displaced.

FIG. 10 shows a three-dimensional view of a powder spray gun operable at high voltage and of the powder tube extension.

FIG. 11 shows a three-dimensional view of a further embodiment of the powder tube extension with a round jet nozzle.

FIG. 12 shows a three-dimensional view of the powder tube extension, wherein the baffle plate is detached.

FIG. 13 shows a three-dimensional view of the powder tube extension, wherein the baffle plate and the round jet nozzle are detached.

FIG. 14 shows the round jet nozzle as viewed from the front.

FIG. 15 shows a longitudinal sectional view of the round jet nozzle.

FIG. 16 shows a three-dimensional view of part of the powder tube extension, wherein the O-ring and the cap nut are displaced on the powder channel.

FIG. 17 shows a three-dimensional view of the guide tube with the cap for the high-voltage electrode and the electrode holder of the powder tube extension.

### DETAILED DESCRIPTION OF THE INVENTION

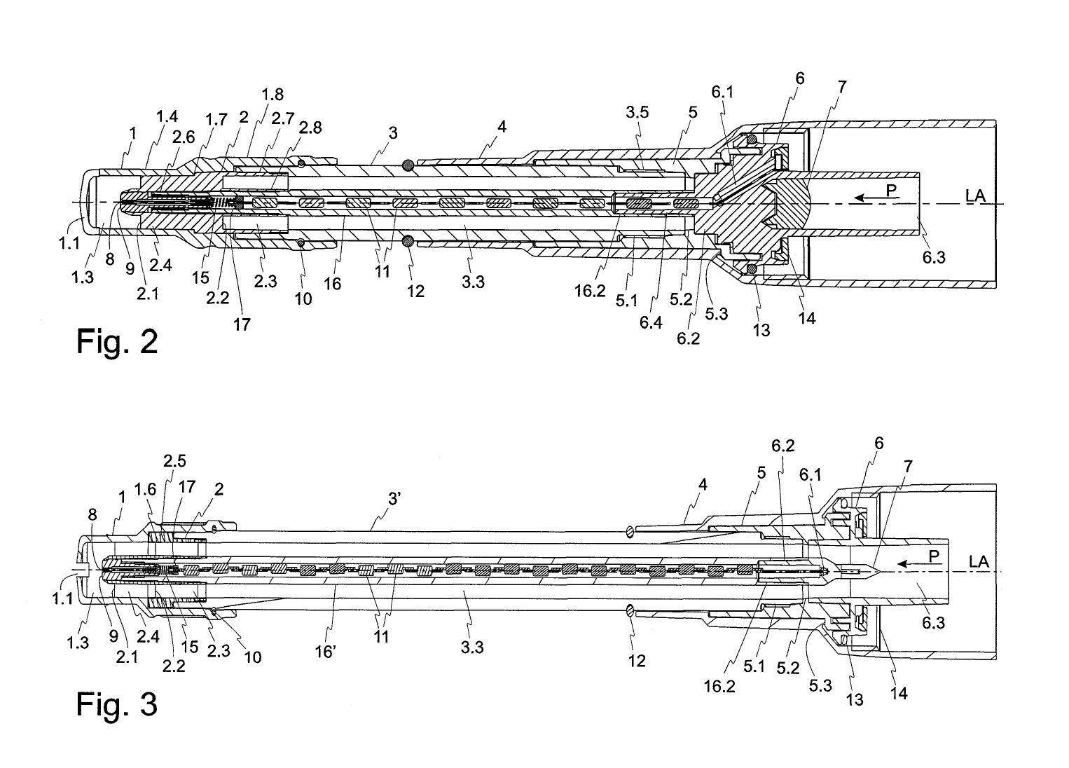

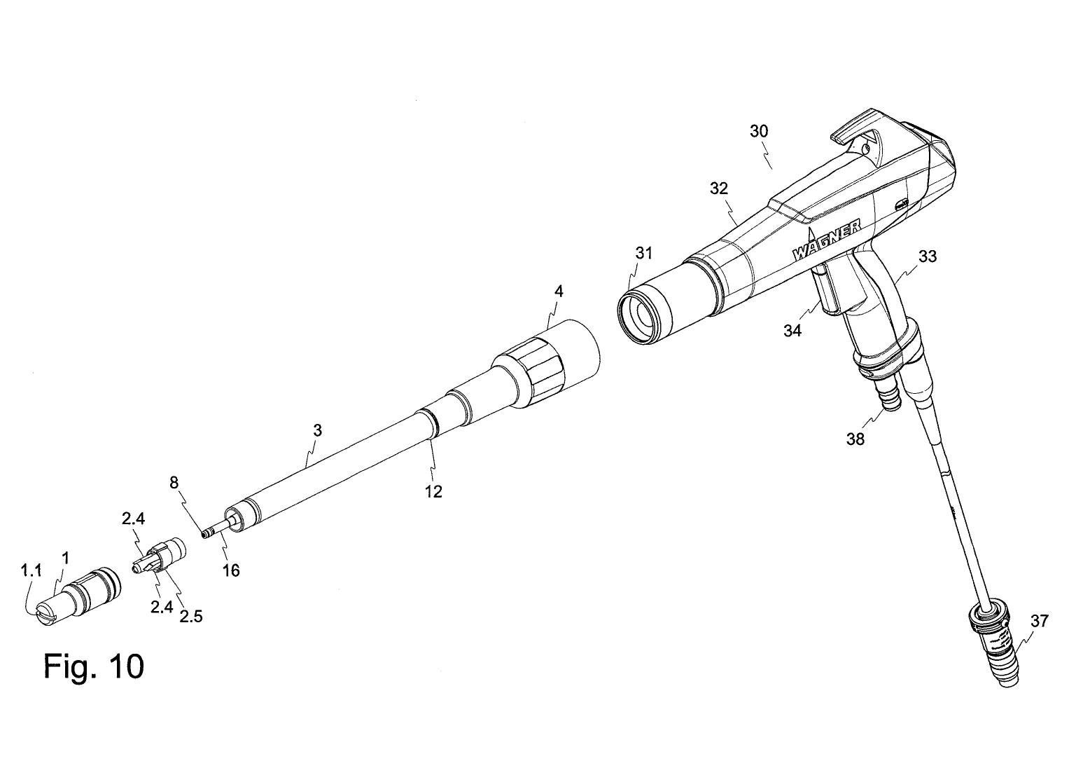

A longitudinal sectional view of a first possible embodiment of the powder tube extension according to the invention is illustrated in FIG. 2. The powder tube extension can be screwed onto a powder spray gun, which will also be referred to hereinafter as a spray gun or gun for short. FIG. 10 shows a possible embodiment of such a powder spray gun 30. The powder tube extension is thus screwed with a cap nut 4 onto the outlet 31 of the powder spray gun 30.

The powder tube extension comprises an extension tube 3, which will also be referred to hereinafter as a powder tube. A connecting sleeve 5 fits on the upstream end 3.5 of the extension tube 3. An electrode holder 6 with a powder wedge 7 is in turn fitted in the upstream end of the connecting sleeve. On its upstream side, the electrode holder 6 has a powder channel 6.3, which forms the inlet of the powder tube extension. The coating powder, or powder for short, flows through the powder channel 6.3 in the direction of the arrow P and is split by the wedge 7 so that it flows past the web 6.2 of the electrode holder 6 without significant swirling and into the powder tube 3. A tubular portion 6.4 is located at the downstream end of the web 6.2. The electrode holder 6 is used to guide the high voltage from the contact point at the downstream end of the spray gun 30 to the resistors 11 in the tube 16. The tube 16 will also be referred to hereinafter as a guide tube. To this end, the electrode holder 6 has an electrically conductive contact ring 14, which is in contact with the contact point of the spray gun 30 as soon as the powder tube extension is screwed onto the gun 30. An electrode channel 6.1 with a wire, of which the end is connected to the contract ring 14, is located inside the electrode holder 6. The other end of the wire is connected to the first of the resistors 11 connected in series. The tube 16 is fitted onto the tubular portion 6.4 of the electrode holder 6. The connection 16.2 between the tubular portion 6.4 and the tube 16 can be formed for example as a press fit, screw connection or adhesive bond.

The tube 16 and the extension tube 3 are arranged concentrically with one another. A cap 9 is located at the downstream end of the tube 16. In the embodiment shown in FIG. 2, the cap 9 is screwed to the tube 16. To this end, it has a thread 9.1 (see FIG. 8). The cap 9 may also be pressed into the tube 16 or glued thereto. The cap 9 has an opening, from which a high-voltage electrode 8, or electrode for short, protrudes. When the spray gun is in operation, the powder flowing past the high-voltage electrode 8 is electrostatically charged.

The cap 9 is advantageously detachable from the tube 16. When the electrode is worn, it is suffice to replace merely the cap 9 with the electrode 8. The tube 16 with the resistors 11 does not need to be replaced. The cap 9 thus formed carries a spring 15 at the upstream end, said spring being electrically connected to the electrode 8. The spring 15 thus forms an electrically spring-loaded contact, which presses against a contact plate 17 at the last resistor 11 in the tube 16.

The tube 16 located inside the powder tube 3 with the resistors 11 connected in series and the cap 9 is held exactly concentrically with the powder tube 3 by means of a wedge insert 2. To this end, the wedge insert 2 has a sleeve-shaped portion 2.7, which fits in the downstream end region of the powder tube 3. This sleeve-shaped portion 2.7 will also be referred to hereinafter as an outer sleeve-shaped portion 2.7. The outer sleeve-shaped portion 2.7 has a tapered portion externally at its upstream end. The wedge insert 2 can thus be fitted more easily into the powder tube 3. In addition, the wedge insert 2 has a further sleeve-shaped portion 2.8, which will also be referred to hereinafter as an inner sleeve-shaped portion 2.8. The end region of the tube 16 fits in said inner sleeve-shaped portion. The outer sleeve-shaped portion 2.7 and the inner sleeve-shaped portion 2.8 are arranged concentrically with one another and are interconnected via two radial webs 2.4. The two webs 2.4 each have a tapered portion 2.2 on the upstream side and are thus conical. The coating powder is thus guided past the two webs 2.4 without any swirling. The risk of the coating powder adhering or sintering to the webs 2.4 is thus considerably reduced. In addition, the wear of the wedge insert 2 is reduced by a suitable geometry of the tapered portions 2.2. Otherwise, the webs 2.4 would become worn over time in particular as a result of abrasive coating powder. The two webs 2.4 advantageously also have tapered portions 2.1 on the downstream side. They reduce the risk that the coating powder is swirled after the webs 2.4.

Lastly, a powder jet nozzle 1 is provided, which will also be referred to hereinafter as a jet nozzle or nozzle. The nozzle has a downstream portion 1.4 and an upstream portion 1.8. The step 1.7 forms the boundary between the two portions 1.4 and 1.8. The step 1.7 additionally forms a depth stop. The nozzle 1 is fitted onto the downstream end of the powder tube 3 and, in so doing, is also fitted simultaneously onto the wedge insert 2. The nozzle 1 reaches its end position when the depth stop 1.7 of the nozzle 1 contacts the annular shoulder of the wedge insert 2. A latched connection ensures that the nozzle 1 does not slip from the powder tube 3 during the coating process. To this end, the nozzle 1 has an O-ring 10, which can latch on the powder tube 3 in a corresponding annular groove.

The powder tube 3 and the wedge insert 2 are shaped such that they form a frictional connection in the assembled state. If the nozzle 1 is then removed from the powder tube 3, the frictional connection ensures that the wedge insert 2 remains in the powder tube 3. If necessary, the operator can remove the wedge insert 2 subsequently from the powder tube 3 by hand. The nozzle 1 can thus be replaced more easily. Specifically, merely the nozzle 1 has to be removed in order to replace said nozzle. No further steps are necessary.

The jet nozzle 1 is formed as a flat jet nozzle in the embodiment shown in FIG. 2. Here, the nozzle opening 1.1 is slit-shaped. During operation, the electrostatically charged coating powder flows through the powder channel 1.3 of the flat jet nozzle and exits from the nozzle 1 in the form of a flat powder jet through the slit-shaped nozzle opening 1.1.

The two radial webs 2.4 of the wedge insert 2 and the slit-shaped nozzle opening 1.1 in the flat jet nozzle 1 are preferably identically oriented. The nozzle slit 1.1 and the two radial webs 2.4 are thus aligned parallel to one another. In order to achieve this, the nozzle 1 internally has an axial groove 1.6 (FIG. 3) and the wedge insert 2 has a lug 2.5 on its outer face. The lug 2.5 of the wedge insert 2 forms an interlocking connection together with the groove 1.6 in the nozzle 1 such that, when the nozzle 1 is rotated about its longitudinal axis LA, the wedge insert 2 is also rotated. The relative position of the wedge insert 2 with respect to the nozzle 1 is thus retained, more specifically irrespective of the orientation of the nozzle 1.

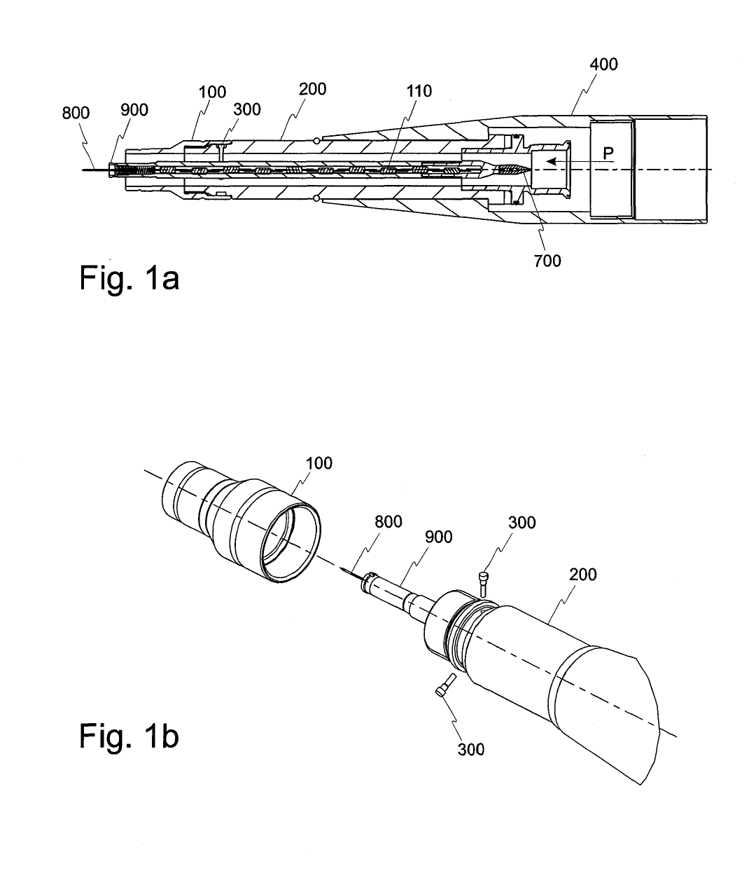

The downstream end of the powder tube 3 fits in the sleeve-shaped portion 1.8 of the nozzle 1 to a depth of approximately 28 mm. The outer sleeve-shaped portion 2.7 of the wedge insert likewise protrudes relatively far into the powder tube 3. The sleeve-shaped portion 2.7, the powder tube 3 and the sleeve-shaped portion 1.8 of the nozzle 1 thus form a labyrinth for the high voltage. The distance or air gap is extended. A further advantage compared to the prior art shown in FIG. 1 lies in the fact that the powder tube 3 now has fewer outwardly directed openings, that is to say the three bores that receive the centering pins 300 are omitted. The distance or air gap in the outward direction is thus also increased further.

The connecting sleeve 5 internally has an annular collar 5.2, which on the one hand forms a stop for the tube 16 and on the other hand forms a stop for the electrode holder 6. The inner wall of the collar 5.2 forms the part of the powder channel that connects the powder channel 6.3 of the electrode holder 6 to the powder channel 3.3 of the powder tube 3.

The cap nut 4 internally has a shoulder 5.3, which is used as a stop for the connecting sleeve 5. When the cap nut 5 is screwed onto the gun, the shoulder 5.3 presses onto the connecting sleeve 5 and fixes it. In addition, the powder channel 6.3 of the electrode holder 6 is also pressed during this process into the powder tube of the spray gun via the stop at the collar 5.3.

The O-ring 12 on the powder tube 3 forms a resilient resistance for the cap nut 4. If necessary, the cap nut 4 can be slid away via the groove on the tube together with the O-ring 12 with a low application of force. The O-ring 12 holds the cap nut 4 in the respective position.

A longitudinal sectional view of a second possible embodiment of the powder tube extension according to the invention is illustrated in FIG. 3. The second embodiment is illustrated rotated through 90° compared to the first embodiment according to FIG. 1. The second embodiment of the powder tube extension differs from the first embodiment by a longer powder tube 3′ and by a longer tube 16′. In addition, some additional resistors 11 connected in series are arranged in the tube 16′. The powder tube 3 according to FIG. 2 for example has a length of 120 mm, and the powder tube 3′ according to FIG. 3 for example has a length of 270 mm. The other components, such as the flat jet nozzle 1, the wedge insert 2, the cap nut 4 and the electrode holder 6 are the same as in the first embodiment according to FIG. 2. The powder tube extension according to FIG. 3 is shown in a compressed manner so that the individual components can be seen more clearly.

Powder tube extension having different lengths can be produced. With the different powder tube extensions, the gun can be extended for example between 150 mm and 500 mm.

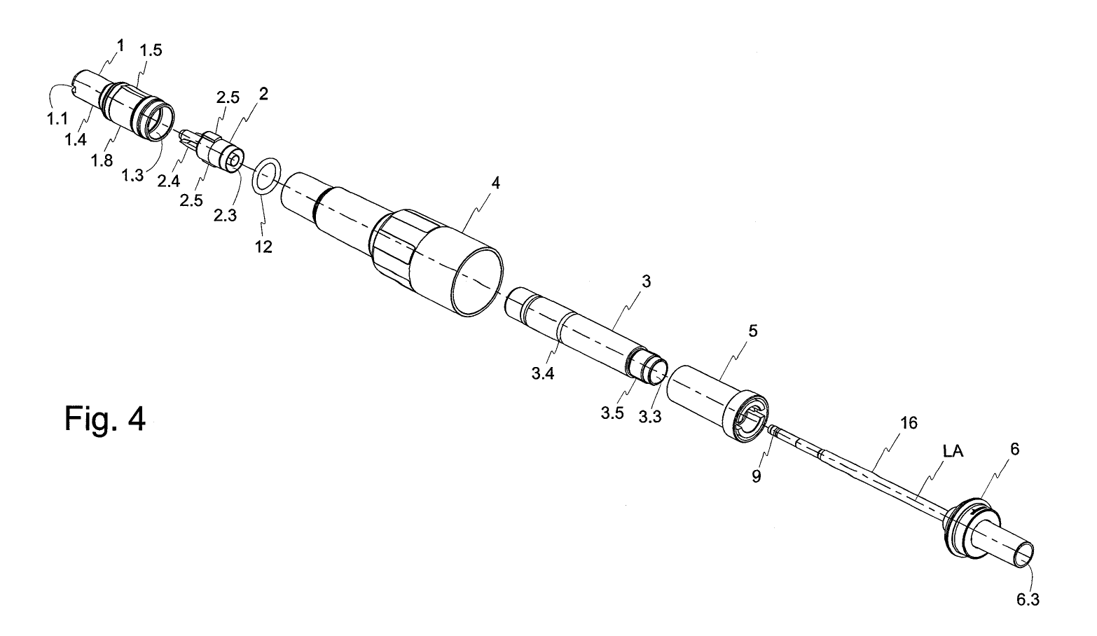

FIG. 4 shows a three-dimensional view of the first embodiment of the powder tube extension in the disassembled state. In this view it can be seen that the flat jet nozzle 1 has a notch 1.5 on its outer face. The notch 1.5 is intended to enable the operator to better determine the orientation of the nozzle slit 1.1.

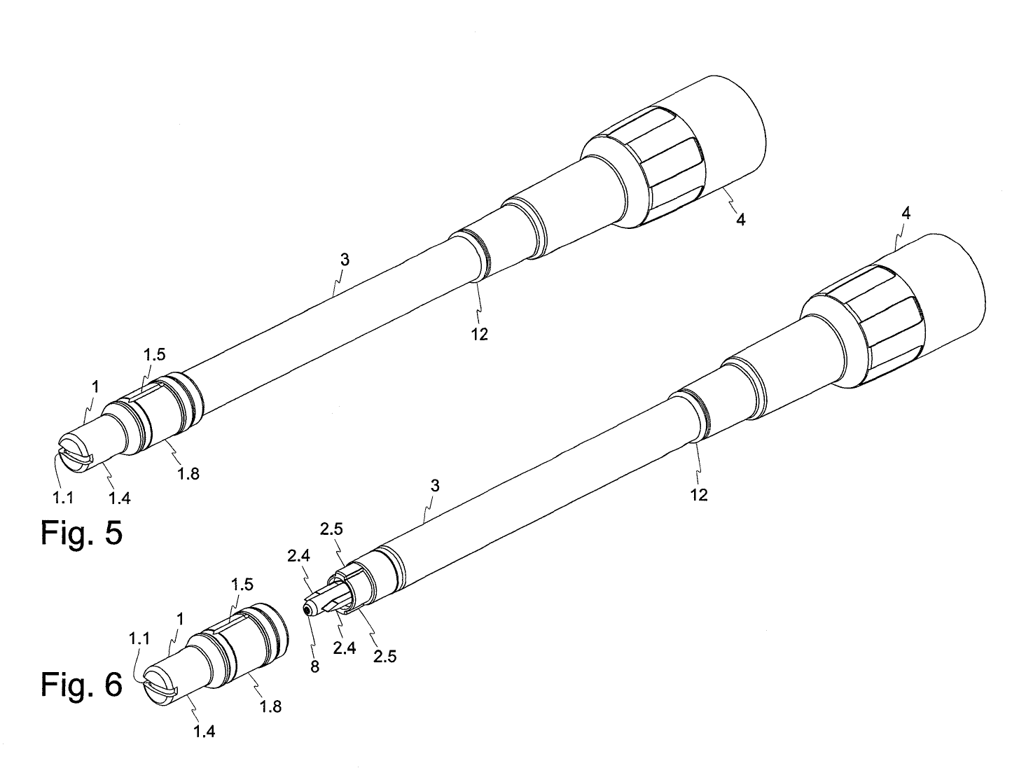

FIG. 5 shows a three-dimensional view of the first embodiment of the powder tube extension in the assembled state.

If the operator wishes to disassemble the powder tube extension, for example for cleaning purposes, he removes the flat jet nozzle 1 by hand from the powder tube 3. In so doing, the wedge insert 2 remains in the powder tube 3, as shown in FIG. 6.

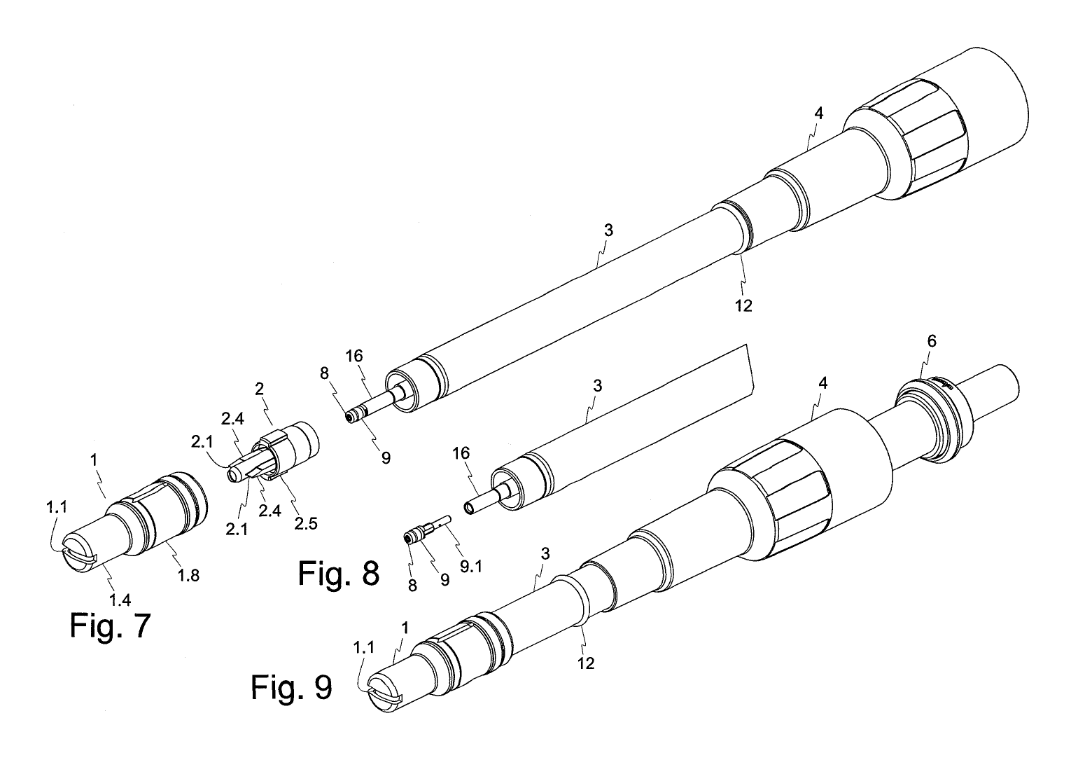

The operator can then also remove the wedge insert 2 from the powder tube 3, as shown in FIG. 7.

As shown in FIG. 8, the cap 9, in which the high-voltage electrode 8 is located, can then also be unscrewed from the tube 16 and replaced as required.

A three-dimensional view of the powder tube extension is illustrated in FIG. 9, wherein the cap nut and the O-ring 12 are displaced toward the nozzle 1 so that the electrode holder 6 is then accessible.

FIG. 10 shows a three-dimensional view of a possible embodiment of the powder spray gun 30 in the assembled state and of the powder tube extension in a partly disassembled state. For the sake of simplicity, the powder spray gun 30 will also be referred to as a spray gun or merely as a gun. The spray gun 30 is formed as a manual spray gun and for this purpose comprises a gun housing 32 with a grip 33, via which the operator can hold the gun. The grip 33 has a trigger 34, via which the coating process can be started and stopped. A powder tube connection 38, via which the gun 30 is supplied with powder, and an electrical connection 37, via which a high-frequency low voltage is supplied to the gun 30, are located at the lower end of the grip 34. A high-voltage generator, which comprises a transformer and a downstream voltage multiplier, is located in the gun 30 and transforms the high-frequency low voltage into a high voltage. Control and information signals can also be fed to the gun via the electrical connection 37 from a control device (not shown in the figure), and control and information signals can also be conveyed from the gun to the control device. As soon as the trigger 34 has been actuated, the coating powder, or powder for short, is sprayed via the spray nozzle 1. As soon as a high voltage is applied to the electrode 8, the powder flowing past the electrode 8 is electrostatically charged.

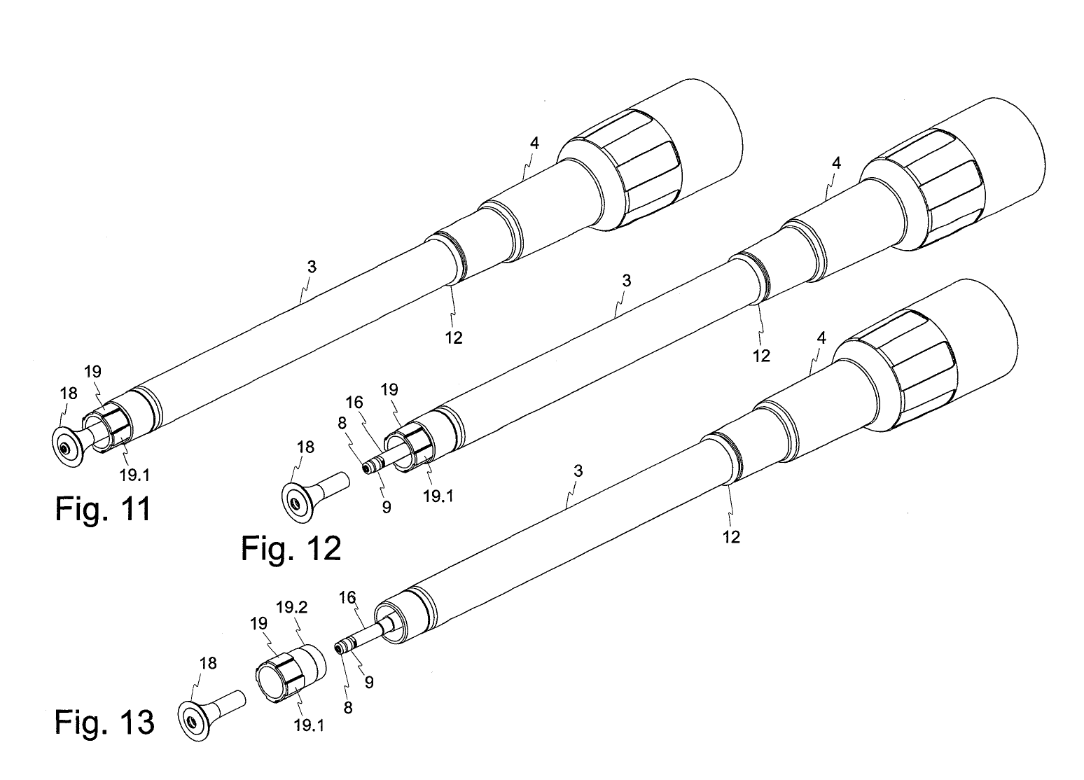

FIG. 11 shows a three-dimensional view of a further embodiment of the powder tube extension with a baffle plate 18 and a round jet nozzle 19.

If the operator wishes to disassemble the powder tube extension, for example for cleaning purposes, he first removes the baffle plate 18 from the guide tube 16. As shown in FIG. 13, the operator can then also remove the round jet nozzle 19 from the powder tube 3.

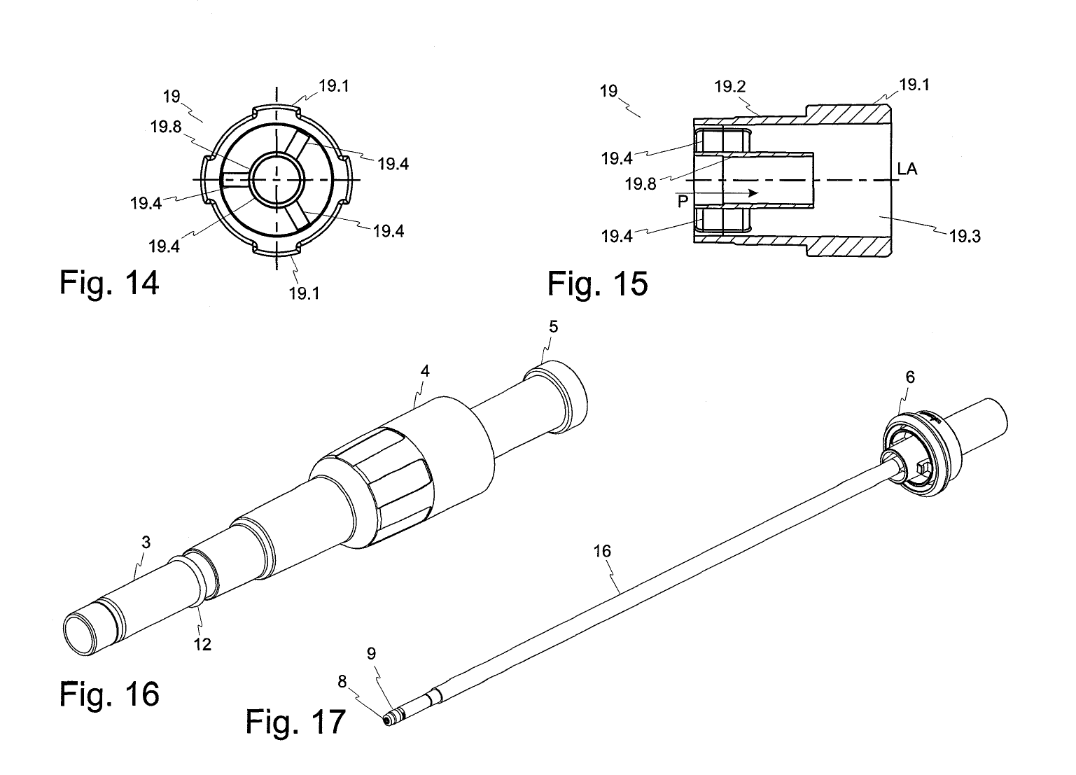

The round jet nozzle 19 also contains the wedge insert. FIG. 14 shows the round jet nozzle 19 as viewed from the front, and FIG. 15 shows the round jet nozzle 19 in longitudinal section. The round jet nozzle 19 has an upstream sleeve-shaped portion 19.2, which can be inserted into the powder tube 3. The sleeve-shaped portion 19.2 will also be referred to hereinafter as the outer sleeve-shaped portion 19.2. The protrusions 19.1 help the nozzle 19 to be better gripped. The wedge insert with a sleeve-shaped portion 19.8, which will also be referred to hereinafter as the inner sleeve-shaped portion, is located inside the round jet nozzle 19. The wedge insert additionally comprises three webs 19.4, which are supported on the outer sleeve-shaped portion 19.2 and hold the inner sleeve-shaped portion 19.8. The inner sleeve-shaped portion 19.8 is intended to receive the guide tube 16 with the cap 9. As shown in FIG. 15, the webs 19.4 may have a wedge-shaped tapered portion on each of the upstream and downstream side. The powder flowing through the powder channel 19.3 of the nozzle 19 is split by the wedge-shaped webs 19.4 and flows toward the nozzle outlet without significant swirling.

FIG. 16 shows a three-dimensional view of part of the powder tube extension, wherein the cap nut 4 and the O-ring 12 are displaced on the powder tube 3 in the direction of the powder outlet.

FIG. 17 shows a three-dimensional view of the tube 16 with the cap 9 for the high-voltage electrode 8 and the electrode holder 6 of the powder tube extension. As soon as the baffle plate 18 has been removed from the tube 16 and the round jet nozzle 19 has been removed from the powder tube 3, the operator can remove the other components illustrated in FIG. 17 from the powder tube 3 in a rearward direction (upstream). This may be carried out for cleaning purposes for example.

The above description of the exemplary embodiments according to the present invention is used merely for illustrative purposes and not for the purpose of limiting the invention. Various changes and modifications are possible within the scope of the invention without departing from the scope of the invention and equivalents thereof. For example, the various components of the powder tube extension shown in FIGS. 2 to 17 can thus also be combined in a manner different from that shown in the figures. For example, the baffle plate 18 and the round jet nozzle 19 can also be fitted onto the powder tube 3′ according to FIG. 3.

The powder tube extension can be formed with different lengths. The length with which the powder tube extension is to be formed can be determined for example by the work pieces to be coated.

The powder tube extension can also be assembled on an automatic gun. An automatic gun is understood to mean a spray gun that is not held by hand, but for example is fastened or fixedly installed on a robot or a linear guide.

Lastly, the powder tube extension may also be screwed onto a powder beaker gun. The powder beaker gun has a powder beaker, including a powder injector, which are attached directly to the spray gun, for example thereabove.

### LIST OF REFERENCE SIGNS

1 flat jet nozzle
1.1 nozzle opening
1.3 powder channel
1.4 sleeve-shaped portion
1.5 notch
1.6 groove
1.7 step
1.8 sleeve-shaped portion
wedge insert
2.1 tapered portion
2.2 tapered portion
2.3 powder channel
2.4 web
2.5 lug
2.6 channel
2.7 outer sleeve-shaped portion
2.8 inner sleeve-shaped portion
3 extension tube
3′ extension tube
3.3 powder channel
3.4 annular groove
3.5 connecting region
4 cap nut
5 guide sleeve connecting part
5.1 thread
5.2 collar
5.3 stop
6 electrode holder
6.1 electrode channel
6.2 web
6.3 powder channel
6.4 tubular portion
7 wedge
8 electrode
9 cap
9.1 thread
10 O-ring
11 resistor
12 O-ring
13 O-ring
14 contact ring
15 spring
16 guide tube for the resistors
16′ guide tube for the resistors
16.2 adhesive bond
17 contact plate
18 baffle plate
19 round jet nozzle including wedge insert
19.1 protrusion
19.2 sleeve-shaped portion
19.3 powder channel
19.4 web
19.8 inner sleeve-shaped portion
30 powder spray gun
31 outlet
32 gun housing
33 grip
34 trigger
37 electrical connection
38 powder tube connection
100 spray nozzle
110 resistor
200 powder tube
300 centering pin
400 cap nut
700 wedge
800 electrode
900 guide tube for the electrode
LA longitudinal axis
P direction of the flow of the powder

1. A wedge insert for a powder tube extension of a powder spray gun operable at high-voltage,
wherein a sleeve is provided,
wherein a radial web, which is formed in a wedge-shaped manner on the upstream side, is provided in the sleeve, and
wherein an axially running channel, into which a guide tube, which guides an electrode for the high voltage, can be inserted, is provided in the web.

2. The wedge insert according to claim 1,
wherein a lug is provided, and
wherein the lug is formed such that, when the wedge insert is fitted in a spray nozzle having a groove, it forms an interlocking connection together with the groove.

3. The wedge insert according to claim 1, wherein the channel is sleeve-shaped and is arranged concentrically with the sleeve.

4. The wedge insert according to claim 1, wherein the sleeve is formed in such a way that it can be inserted into a powder tube of the powder tube extension and in so doing forms a frictional connection with the powder tube.

5. The wedge insert according to claim 4, wherein the sleeve tapers in the upstream end region.

6. A powder tube extension for a powder spray gun that can be operable at high voltage, with a wedge insert according to claim 1,
wherein a central guide tube is provided, in which resistors are arranged,
wherein a powder tube arranged concentrically with the guide tube is provided,
wherein the wedge insert and a spray nozzle are provided at the downstream end of the powder tube.

7. The powder tube extension according to claim 6, wherein a cap is provided, which is connected to the guide tube by means of a detachable connection.

8. The powder tube extension according to claim 6, wherein a groove is provided in the spray nozzle and is formed such that it forms an interlocking connection with the lug of the wedge insert.

9. The powder tube extension according to claim 6, wherein a latched connection is provided between the spray nozzle and the powder tube.

10. The powder tube extension according to claim 9, wherein the spray nozzle has an O-ring and the powder tube has a groove for the latched connection.

11. The powder tube extension according to claim 6, wherein the spray nozzle has a sleeve-shaped portion, which can be fitted onto the powder tube.

12. The powder tube extension according to claim 6, wherein a baffle plate is provided, which can be fitted onto the guide tube.

13. A flat jet nozzle for a powder tube extension of a powder spray gun operable at high voltage,
wherein a nozzle slit is provided,
wherein a tubular portion is provided, which is formed in such a way that at least the downstream portion of a radially arranged wedge of a wedge insert can be placed therein with an interlocking fit,
wherein a groove is provided in a further tubular portion and is formed such that, when the wedge insert is connected to the flat jet nozzle, said groove forms an interlocking connection with the lug of the wedge insert so that the wedge and the nozzle slit have the same orientation,
wherein a step is provided between the tubular portion and the further tubular portion.

14. The flat jet nozzle according to claim 13, wherein the further tubular portion is formed in such a way that it can be fitted at least 25 mm onto the powder tube.

15. Use of the powder tube extension according to claim 1 in a manually operable powder spray gun or an automatic spray gun.
